(19) United States
(12) Patent Application Publication
(10) Pub. No.: US 2026/0092783 A1
(43) Pub. Date: Apr. 2, 2026

(54) Sensor Module

(71) Applicant: SEIKO EPSON CORPORATION, Tokyo (JP)

(72) Inventors: Taketo CHINO, Hokuto (JP); Yoshikuni SAITO, Kofu (JP); Masayasu SAKUMA, Shiojiri (JP)

(21) Appl. No.: 19/341,104

(22) Filed: Sep. 26, 2025

(30) Foreign Application Priority Data
Sep. 27, 2024 (JP) 2024-169478

(51) Int. Cl. G01C 21/16

(52) U.S. Cl. CPC G01C 21/16

(57) ABSTRACT

A sensor module includes a sensor substrate including a circuit substrate and an inertial sensor mounted on the circuit substrate, a package including a main body portion having a first surface and a second surface in a front-back relationship and a side surface coupling the first surface and the second surface and housing the sensor substrate inside, and a fixing portion extending out from the main body portion along the first surface and fixed to an object, and a flexible wiring portion electrically coupled to the sensor substrate and extending from the side surface to an outside of the package.

The present application is based on, and claims priority from JP Application Serial Number 2024-169478, filed September 27, 2024, the disclosure of which is hereby incorporated by reference herein in its entirety.

### BACKGROUND

### 1. Technical Field

The present disclosure relates to a sensor module.

### 2. Related Art

An inertial measurement device described in JP-A-2019-163955 includes an inner case, a circuit substrate mounted on a lower surface of the inner case, and an outer case that covers the inner case and houses the circuit substrate between the inner case and itself. A Z-axis angular velocity sensor, a triaxial acceleration sensor, and a plug-type connector are mounted on an upper surface of the circuit substrate, a microcontroller is mounted on a lower surface of the circuit substrate, and an X-axis angular velocity sensor and a Y-axis angular velocity sensor are mounted on side surfaces of the circuit substrate.

JP-A-2019-163955 is an example of the related art.

However, in the inertial measurement device in JP-A-2019-163955, since the plug-type connector is disposed in a standing attitude with respect to the circuit substrate, it is difficult to reduce the height of the entire device.

### SUMMARY

A sensor module according to an aspect of the present disclosure includes a sensor substrate including a circuit substrate and an inertial sensor mounted on the circuit substrate, a package including a main body portion having a first surface and a second surface in a front-back relationship and a side surface coupling the first surface and the second surface and housing the sensor substrate inside, and a fixing portion extending out from the main body portion along the first surface and fixed to an object, and a flexible wiring portion electrically coupled to the sensor substrate and extending from the side surface to an outside of the package.

### BRIEF DESCRIPTION OF THE DRAWINGS

FIG. 1 is a perspective view showing a sensor module according to a first embodiment.

FIG. 2 is an exploded perspective view of the sensor module.

FIG. 3 is a top view of a sensor substrate.

FIG. 4 is a cross-sectional view of an acceleration sensor.

FIG. 5 is a plan view showing an angular velocity sensor.

FIG. 6 is a schematic diagram showing a driving state of the angular velocity sensor.

FIG. 7 is a schematic diagram showing a driving state of the angular velocity sensor.

FIG. 8 is a top view showing a modification of a flexible wiring portion.

FIG. 9 is a top view showing a modification of the flexible wiring portion.

FIG. 10 is a perspective view of a sensor module according to a second embodiment.

FIG. 11 is a cross-sectional view of the sensor module.

FIG. 12 is a top view showing a sensor module according to a third embodiment.

FIG. 13 is a cross-sectional view showing a sensor module according to a fourth embodiment.

FIG. 14 is a top view showing a modification of the sensor module.

FIG. 15 is a top view showing a modification of the sensor module.

FIG. 16 is a top view showing a modification of the sensor module.

FIG. 17 is a top view showing a modification of the sensor module.

FIG. 18 is a top view showing a modification of the sensor module.

FIG. 19 is a top view showing a modification of the sensor module.

FIG. 20 is a top view showing a modification of the sensor module.

FIG. 21 is a top view showing a modification of the sensor module.

FIG. 22 is a top view showing a modification of the sensor module.

FIG. 23 is a cross-sectional view showing a modification of the sensor module.

### DESCRIPTION OF EMBODIMENTS

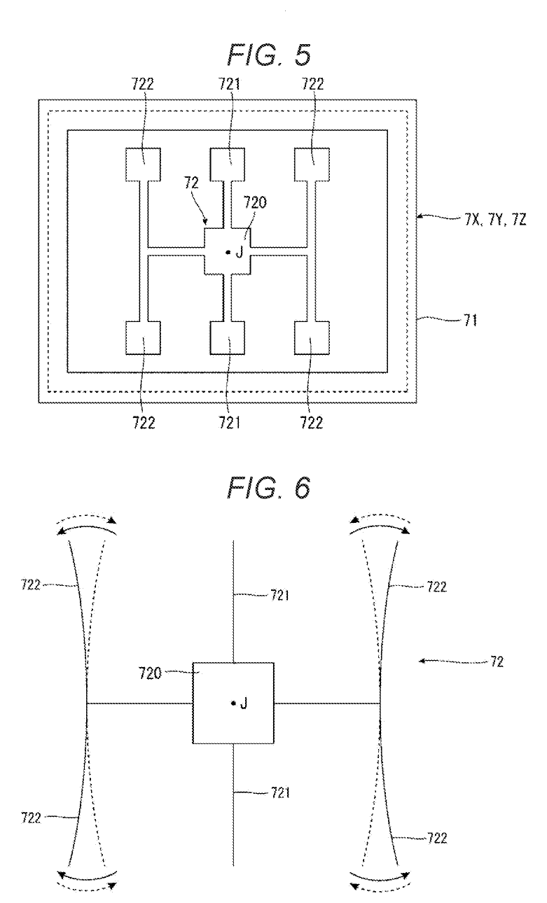

Hereinafter, a sensor module of the present disclosure will be described in detail based on embodiments shown in the accompanying drawings. Note that, for convenience of description, three axes orthogonal to one another are shown as an X axis, a Y axis, and a Z axis in the respective drawings except FIGS. 5 to 7. Further, hereinafter, for convenience of description, a direction parallel to the X axis is also referred to as "X-axis direction", a direction parallel to the Y axis is also referred to as "Y-axis direction", and a direction parallel to the Z axis is also referred to as "Z-axis direction". A side indicated by an arrowhead on each axis is also referred to as a "positive side", and an opposite side is also referred to as a "negative side". Further, the arrowhead side in the Z-axis direction is also referred to as "upper", and the opposite side is also referred to as "lower".

### First Embodiment

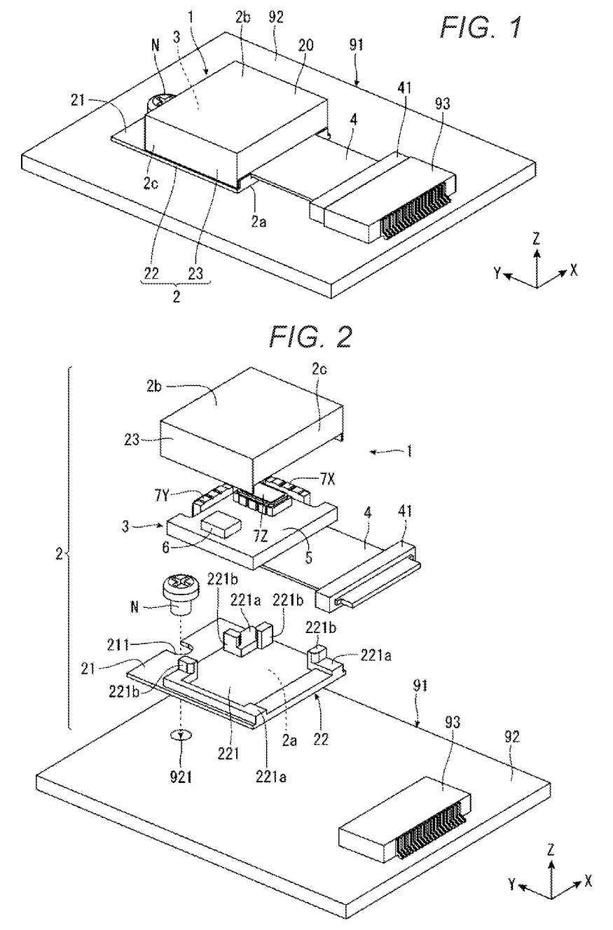

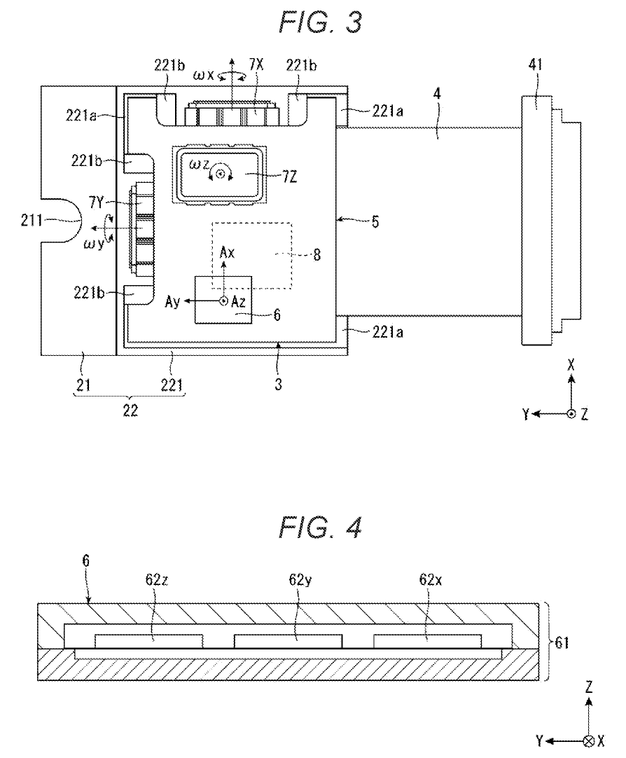

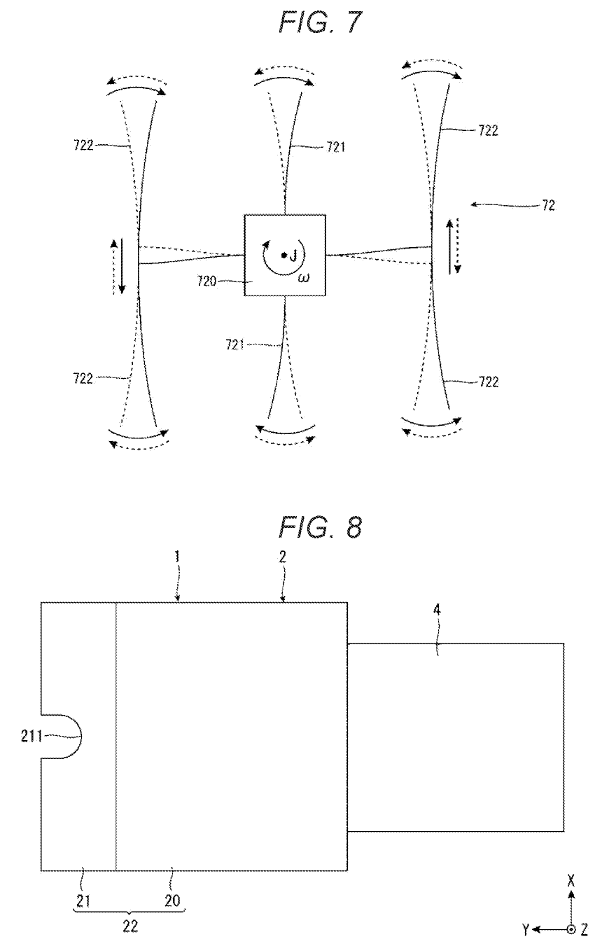

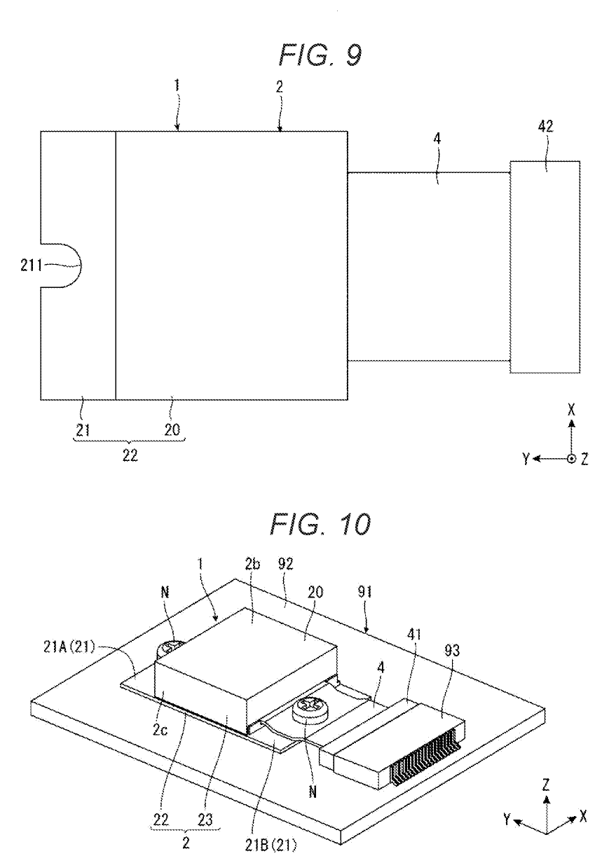

FIG. 1 is a perspective view showing a sensor module according to a first embodiment. FIG. 2 is an exploded perspective view of the sensor module. FIG. 3 is a top view of a sensor substrate. FIG. 4 is a cross-sectional view of an acceleration sensor. FIG. 5 is a plan view showing the angular velocity sensor. FIGS. 6 and 7 are respectively schematic diagrams showing driving states of the angular velocity sensor. FIGS. 8 and 9 are respectively top views showing modifications of a flexible wiring portion.

A sensor module 1 illustrated in FIG. 1 is an inertial measurement sensor unit (IMU: Inertial Measurement Unit) that independently measures an angular velocity around each axis of the X axis, the Y axis, and the Z axis and an acceleration in each axis direction of the X axis, the Y axis, and the Z axis. The sensor module 1 includes a package 2, a sensor substrate 3 housed in the package 2, and a flexible wiring portion 4 electrically coupled to the sensor substrate 3 and extending out from the package 2.

### Package 2

As illustrated in FIG. 1, the package 2 includes a main body portion 20 having a housing space inside, and a fixing portion 21 protruding from the main body portion 20 toward the positive side in the Y-axis direction. The main body portion 20 has a cubic shape, and has a lower surface 2a as a first surface and an upper surface 2b as a second surface in a front-back relationship, and a frame-shaped side surface 2c coupling the lower surface 2a and the upper surface 2b. Since the lower surface 2a is formed along an X-Y plane, a "plan view from the Z-axis direction" frequently used below is synonymous with a "plan view of the lower surface 2a".

As illustrated in FIG. 2, the package 2 includes an inner case 22 forming a part of the main body portion 20 and the fixing portion 21, and an outer case 23 forming a part of the main body portion 20. The outer case 23 covers the inner case 22 from above. In the package 2, the inner case 22 forms the lower surface 2a, and the outer case 23 forms the upper surface 2b.

The inner case 22 and the outer case 23 are respectively formed using aluminum (Al). Thereby, the package 2 having higher rigidity is obtained. In particular, in the present embodiment, alumite treatment is respectively performed on the surfaces of the inner case 22 and the outer case 23 to isolate the package 2. The constituent material of the inner case 22 and the outer case 23 is not particularly limited, but, for example, a metal material such as titanium, magnesium, or stainless steel, or ceramics such as alumina or titania may be used.

The inner case 22 has a plate shape and includes a base portion 221 forming a part of the main body portion 20 and the fixing portion 21 protruding from the base portion 221 toward the positive side in the Y-axis direction. The base portion 221 has a square shape in a plan view from the Z-axis direction. Further, the base portion 221 includes mount parts 221a erected along an edge thereof, on which the sensor substrate 3 is mounted. Furthermore, the base portion 221 includes a plurality of positioning protrusions 221b that are erected so as to protrude toward the upper side than the mount parts 221a and position the sensor substrate 3 with respect to the mount parts 221a.

The fixing portion 21 extends out from the main body portion 20 along the lower surface 2a. In particular, in the present embodiment, the lower surface of the fixing portion 21 is formed of a surface continuous with the lower surface 2a. The fixing portion 21 has a rectangular plate shape. The width (the length in the X-axis direction) of the fixing portion 21 is equal to the width (the length in the X-axis direction) of the base portion 221. A screw insertion hole 211 through which a screw N is inserted is formed in the fixing portion 21. The screw insertion hole 211 is formed as a cutout that opens to an end surface of the fixing portion 21. As will be described later, the sensor module 1 is fixed to a mounting board 91 by fastening the screw N inserted into the screw insertion hole 211 to the mounting board 91 as an object.

The outer case 23 is a rectangular parallelepiped box having a recess that opens to the lower surface. The outer case 23 covers the inner case 22 from above by inserting the base portion 221 of the inner case 22 into the recess. The inner case 22 and the outer case 23 are bonded and fixed by an adhesive (not shown). The method of fixing the inner case 22 and the outer case 23 is not particularly limited, but may be, for example, fixing by screwing.

Although the package 2 has been described above, the configuration of the package 2 is not particularly limited. For example, in the present embodiment, the inner case 22 includes the fixing portion 21, however, the present disclosure is not limited thereto, and the outer case 23 may include the fixing portion 21. Further, in the present embodiment, the package 2 has the configuration formed by assembling the two members of the inner case 22 and the outer case 23, however, the present disclosure is not limited thereto, and for example, at least one of the inner case 22 and the outer case 23 may be divided into a plurality of components and three or more members may be assembled.

### Sensor Substrate 3

As shown in FIG. 3, the sensor substrate 3 includes a circuit substrate 5, an acceleration sensor 6, an X-axis angular velocity sensor 7X, a Y-axis angular velocity sensor 7Y, and a Z-axis angular velocity sensor 7Z as inertial sensors, and a circuit element 8.

The circuit substrate 5 includes, for example, a rigid substrate such as a multilayer glass epoxy substrate. The lower surface of the circuit substrate 5 is fixed to the upper surfaces of the mount parts 221a via an adhesive (not shown). The method of fixing the circuit substrate 5 to the upper surfaces of the mount parts 221a is not particularly limited, but may be, for example, fixing by screwing.

As shown in FIG. 3, the acceleration sensor 6 is mounted on the upper surface of the circuit substrate 5 so as to face the positive side in the Z-axis direction. The acceleration sensor 6 is a three-axis acceleration sensor that can independently detect an acceleration Ax in the X-axis direction, an acceleration Ay in the Y-axis direction, and an acceleration Az in the Z-axis direction.

As illustrated in FIG. 4, the acceleration sensor 6 includes a package 61 and sensor elements 62x, 62y, and 62z housed in the package 61. The acceleration sensor is electrically coupled to the circuit substrate 5 via a coupling terminal (not shown) disposed in the package 61.

The sensor element 62x is an element that detects the acceleration Ax in the X-axis direction, the sensor element 62y is an element that detects the acceleration Ay in the Y-axis direction, and the sensor element 62z is an element that detects the acceleration Az in the Z-axis direction. Although not illustrated, the sensor elements 62x, 62y, and 62z are silicon MEMS vibrator elements having fixed electrodes fixed to the package 61 and movable electrodes variable with respect to the package 61. In the sensor elements 62x, 62y, and 62z, when the acceleration in the detection axis direction is applied, the movable electrode is displaced with respect to the fixed electrode, and accordingly, the capacitance formed between the fixed electrode and the movable electrode changes. Thus, the changes in the capacitance of the sensor elements 62x, 62y, and 62z can be extracted as detection signals and the accelerations in the respective axis directions can be obtained based on the extracted detection signals.

The acceleration sensor 6 has been described above, however, the configuration of the acceleration sensor 6 is not particularly limited. For example, as the sensor elements 62x, 62y, and 62z, quartz crystal vibrator elements may be used.

As shown in FIG. 3, the X-axis angular velocity sensor 7X is mounted on the side surface of the circuit substrate 5 so as to face the positive side in the X-axis direction. The X-axis angular velocity sensor 7X detects an angular velocity ωx around the X axis. The Y-axis angular velocity sensor 7Y is mounted on the side surface of the circuit substrate 5 so as to face the positive side in the Y-axis direction. The Y-axis angular velocity sensor 7Y detects an angular velocity ωy around the Y axis. The Z-axis angular velocity sensor 7Z is mounted on the upper surface of the circuit substrate 5 so as to face the positive side in the Z-axis direction. The Z-axis angular velocity sensor 7Z detects an angular velocity ωz around the Z axis.

As shown in FIG. 5, each of the X-axis angular velocity sensor 7X, the Y-axis angular velocity sensor 7Y, and the Z-axis angular velocity sensor 7Z includes a package 71 and a sensor element 72 housed in the package 71. The sensors are electrically coupled to the circuit substrate 5 via a coupling terminal (not shown) disposed in the package 71.

The sensor element 72 is, for example, a quartz crystal vibrator element, and includes a base portion 720, four drive vibration arms 722, and two detection vibration arms 721. In the sensor element 72, as shown in FIG. 6, when an angular velocity ω around a detection axis J is applied while the drive vibration arms 722 are drive-vibrated by application of a drive signal, as shown in FIG. 7, detection vibration is excited in the detection vibration arms 721 by the Coriolis force. The electric charge generated in the detection vibration arms 721 by the detection vibration is extracted as a detection signal, and the angular velocity ω can be obtained based on the extracted detection signal.

The configurations of the X-axis angular velocity sensor 7X, the Y-axis angular velocity sensor 7Y, and the Z-axis angular velocity sensor 7Z have been collectively described above. The X-axis angular velocity sensor 7X is disposed such that the detection axis J is along the X axis, the Y-axis angular velocity sensor 7Y is disposed such that the detection axis J is along the Y axis, and the Z-axis angular velocity sensor 7Z is disposed such that the detection axis J is along the Z axis. Accordingly, the angular velocity ωx can be detected by the X-axis angular velocity sensor 7X, the angular velocity ωy can be detected by the Y-axis angular velocity sensor 7Y, and the angular velocity ωz can be detected by the Z-axis angular velocity sensor 7Z.

The configurations of the X-axis angular velocity sensor 7X, the Y-axis angular velocity sensor 7Y, and the Z-axis angular velocity sensor 7Z are not particularly limited. For example, a silicon MEMS vibration element may be used as the sensor element 72.

As shown in FIG. 3, the circuit element 8 is mounted on the lower surface of the circuit substrate 5. The circuit element 8 is electrically coupled to the acceleration sensor 6, the X-axis angular velocity sensor 7X, the Y-axis angular velocity sensor 7Y, and the Z-axis angular velocity sensor 7Z via the circuit substrate 5. The circuit element 8 is, for example, an MCU (Micro Controller Unit), and performs integrated control of the respective portions of the sensor module 1. Specifically, the circuit element 8 includes a control circuit that controls driving of the acceleration sensor 6, the X-axis angular velocity sensor 7X, the Y-axis angular velocity sensor 7Y, and the Z-axis angular velocity sensor 7Z via the circuit substrate 5, and an interface circuit that communicates with the outside.

The control circuit controls driving of the acceleration sensor 6, the X-axis angular velocity sensor 7X, the Y-axis angular velocity sensor 7Y, and the Z-axis angular velocity sensor 7Z, detects the accelerations Ax, Ay, and Az based on the detection signal output from the acceleration sensor 6, and detects the angular velocities ωx, ωy, and ωz based on the detection signals output from the X-axis, Y-axis, and Z-axis angular velocity sensors 7X, 7Y, and 7Z. The interface circuit transmits and receives signals, receives commands from the outside, and outputs the detected accelerations Ax, Ay, and Az and the detected angular velocities ωx, ωy, and ωz to the outside.

The sensor substrate 3 has been described above, however, the configuration of the sensor substrate 3 is not particularly limited. For example, in the present embodiment, the acceleration sensor 6, the X-axis angular velocity sensor 7X, the Y-axis angular velocity sensor 7Y, and the Z-axis angular velocity sensor 7Z are provided as the inertial sensors, however, the present disclosure is not limited thereto, and at least one inertial sensor may be provided.

### Flexible Wiring Portion 4

As shown in FIGS. 2 and 3, the flexible wiring portion 4 is electrically coupled to the circuit substrate 5, and has a function of electrically coupling the circuit substrate 5 to the mounting board 91. The flexible wiring portion 4 is wiring having flexibility, and includes, for example, a flexible substrate. In particular, in the present embodiment, the circuit substrate 5 and the flexible wiring portion 4 are integrally formed using a rigid flexible substrate in which a rigid substrate serving as the circuit substrate 5 and a flexible substrate serving as the flexible wiring portion 4 are coupled. Accordingly, the device configuration of the sensor module 1 is simplified. In addition, since the circuit substrate 5 and the flexible wiring portion 4 can be coupled without using a component such as a connector, the number of components can be reduced, and the sensor module 1 can be reduced in size, height, weight, and the like.

The flexible wiring portion 4 is coupled to an end of the circuit substrate 5 at the negative side in the Y-axis direction, and extends to the outside of the package 2 from a surface facing the negative side in the Y-axis direction of the side surface 2c of the main body portion 20. A connector 41 is attached to a free end of the flexible wiring portion 4, and the flexible wiring portion is coupled to an external device via the connector 41.

The configuration of the sensor module 1 has been described above. The sensor module 1 is mounted on the mounting board 91 as shown in FIGS. 1 and 2. As illustrated in FIG. 2, the mounting board 91 includes a circuit substrate 92 and a connector 93 mounted on the upper surface of the circuit substrate 92. A screw hole 921 for fastening the screw N is formed in the circuit substrate 92. First, the connector 41 provided in the flexible wiring portion 4 is coupled to the connector 93 of the mounting board 91. Accordingly, the sensor module 1 and the mounting board 91 are electrically coupled to each other. Then, the sensor module 1 is placed on the upper surface of the circuit substrate 92 in an attitude in which the lower surface 2a faces the mounting board 91 side. Then, the sensor module 1 is fixed to the circuit substrate 92 by fastening the screw N inserted into the screw insertion hole 211 formed in the fixing portion 21 of the package 2 to the screw hole 921. Thus, the mounting of the sensor module 1 on the mounting board 91 is completed. According to the configuration, the sensor module 1 is fixed to the mounting board 91 at two positions of the connector 41 and the screw N. Therefore, the sensor module 1 can be fixed to the mounting board 91 in a stable attitude. In particular, by screwing one of these positions, the attitude of the sensor module 1 becomes more stable.

In the present embodiment, the fixing portion 21 is disposed at the side opposite to the flexible wiring portion 4 with respect to the main body portion 20 of the package 2. That is, the flexible wiring portion 4 is disposed at the negative side in the Y-axis direction of the main body portion 20, whereas the fixing portion 21 is disposed at the positive side in the Y-axis direction of the main body portion 20. According to the configuration, the two fixing points fixed to the mounting board 91 can be separated as much as possible, and the mounting stability of the sensor module 1 increases.

In the present embodiment, the connector 41 attached to the end part of the flexible wiring portion 4 is electrically coupled to the connector 93 of the mounting board 91, but the present disclosure is not limited thereto. For example, as illustrated in FIG. 8, the connector 41 may be omitted from the end part of the flexible wiring portion 4, and the end part of the flexible wiring portion 4 may be directly coupled to the connector 93. Further, as shown in FIG. 9, a rigid substrate 42 may be disposed in the end part of the flexible wiring portion 4 instead of the connector 41, and the rigid substrate 42 may be coupled to the connector 93.

The sensor module 1 has been described above. As described above, the sensor module 1 includes the circuit substrate 5, the sensor substrate 3 including the acceleration sensor 6, the X-axis angular velocity sensor 7X, the Y-axis angular velocity sensor 7Y, and the Z-axis angular velocity sensor 7Z as the inertial sensors mounted on the circuit substrate 5, the package 2 including the main body portion 20 having the lower surface 2a as the first surface and the upper surface 2b as the second surface in the front-back relationship and the side surface 2c coupling the lower surface 2a and the upper surface 2b, and housing the sensor substrate 3 inside, and the fixing portion 21 extending out from the main body portion 20 along the lower surface 2a and fixed to the mounting board 91 as the object, and the flexible wiring portion 4 electrically coupled to the sensor substrate 3 and extending from the side surface 2c to the outside of the package 2. According to the configuration, the sensor module 1 can be electrically coupled to the mounting board 91 via the flexible wiring portion 4. Therefore, it is not necessary to mount a connector on the circuit substrate 5 as in the related art. As described above, it is not necessary to mount the connector on the circuit substrate 5, further, the flexible wiring portion 4 is extended from the side surface 2c of the package 2 to the outside, and thus the height of the sensor module 1 can be reduced.

Further, as described above, the circuit substrate 5 and the flexible wiring portion 4 are configured using the rigid flexible substrate having the rigid substrate as the circuit substrate 5 and the flexible substrate as the flexible wiring portion 4. According to the configuration, the device configuration of the sensor module 1 is simplified. In addition, since the circuit substrate 5 and the flexible wiring portion 4 can be electrically coupled to each other without using a component such as a connector, the number of components can be reduced, and the sensor module 1 can be reduced in height, weight, and the like.

As described above, the screw insertion hole 211 through which the screw N is inserted is formed in the fixing portion 21, and the fixing portion 21 is fixed to the mounting board 91 by the screw N. According to the configuration, the sensor module 1 can be fixed to the mounting board 91 in a more stable attitude.

As described above, the fixing portion 21 is disposed at the side opposite to the flexible wiring portion 4 with respect to the main body portion 20 in the plan view of the lower surface 2a. According to the configuration, the two fixing points fixed to the mounting board 91 can be separated as much as possible, and the mounting stability of the sensor module 1 increases.

### Second Embodiment

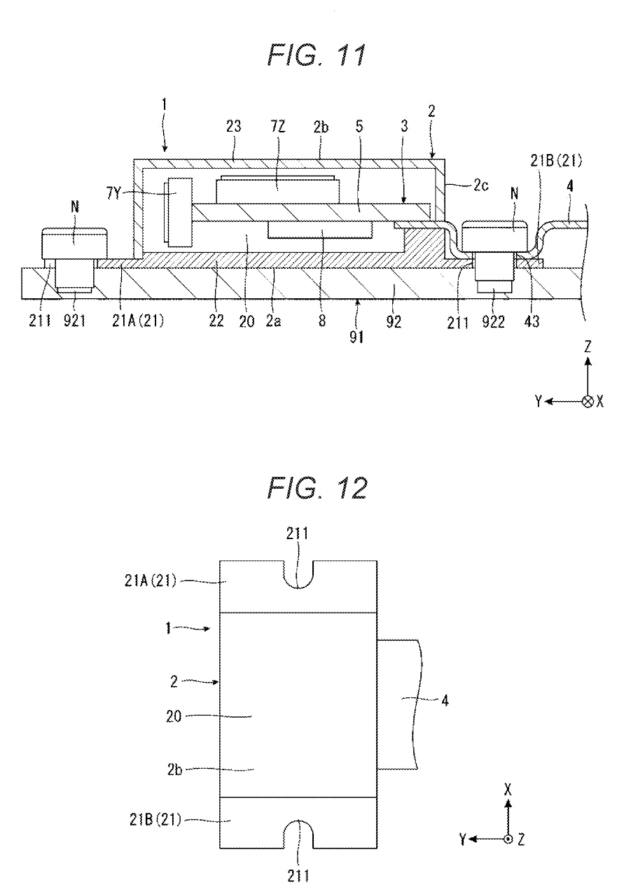

FIG. 10 is a perspective view of a sensor module according to a second embodiment. FIG. 11 is a cross-sectional view of the sensor module.

The sensor module 1 of the present embodiment is the same as that of the first embodiment described above except that the configuration of the package 2 is different. In the following description, the present embodiment will be described with a focus on the differences from the above-described first embodiment, and the description of the same matters will be omitted. In the respective drawings of the present embodiment, the same configurations as those in the above-described embodiment have the same signs.

As illustrated in FIGS. 10 and 11, the fixing portion 21 includes a first fixing portion 21A and a second fixing portion 21B disposed at opposite sides with respect to the main body portion 20 in the plan view from the Z-axis direction. The first fixing portion 21A is disposed at the side opposite to the flexible wiring portion 4, that is, at the positive side in the Y-axis direction with respect to the main body portion 20, and the second fixing portion 21B is disposed at the flexible wiring portion 4 side, that is, at the negative side in the Y-axis direction with respect to the main body portion 20. Therefore, the second fixing portion 21B overlaps the flexible wiring portion 4 in the plan view from the Z-axis direction. As shown in FIG. 11, each of the first and second fixing portions 21A and 21B has the screw insertion hole 211 through which a screw N is inserted. The screw insertion hole 211 of the first fixing portion 21A is formed as a cutout that opens to the end surface of the first fixing portion 21A, and the screw insertion hole 211 of the second fixing portion 21B is formed as a closed hole.

As shown in FIG. 11, a screw insertion hole 43 through which the screw N is inserted is also formed in a part overlapping the screw insertion hole 211 formed in the second fixing portion 21B of the flexible wiring portion 4.

In the mounting board 91, two screw holes 921 and 922 for screwing the screws N are formed in the circuit substrate 92.

In the sensor module 1 having the configuration, as shown in FIG. 11, the sensor module 1 is fixed to the circuit substrate 92 by fastening the screw N inserted through the screw insertion hole 211 formed in the first fixing portion 21A to the screw hole 921 and fastening the screw N inserted through the screw insertion hole 43 formed in the flexible wiring portion 4 and the screw insertion hole 211 formed in the second fixing portion 21B to the screw hole 922. As described above, by screwing the sensor module 1 to the mounting board 91 at two positions, the sensor module 1 can be fixed to the mounting board 91 in a more stable attitude. In particular, as in the present embodiment, by fixing the flexible wiring portion 4 to the mounting board 91 together with the package 2, unnecessary vibration of the flexible wiring portion 4 can be effectively suppressed.

As described above, in the sensor module 1 of the present embodiment, the fixing portion 21 includes the first fixing portion 21A and the second fixing portion 21B disposed at the opposite sides with respect to the main body portion 20 in the plan view of the lower surface 2a. According to the configuration, since the package 2 is fixed to the mounting board 91 at the two positions of the first fixing portion 21A and the second fixing portion 21B, the sensor module 1 can be fixed to the mounting board 91 in a more stable attitude.

As described above, in the plan view of the lower surface 2a, the first fixing portion 21A is disposed at the side opposite to the flexible wiring portion 4, and the second fixing portion 21B is disposed at the flexible wiring portion 4 side. The flexible wiring portion 4 overlaps the second fixing portion 21B and is fixed to the mounting board 91 together with the second fixing portion 21B. According to the configuration, unnecessary vibration of the flexible wiring portion 4 can be effectively suppressed.

According to the second embodiment, the same effects as those in the above-described first embodiment can still be exerted.

### Third Embodiment

FIG. 12 is a top view showing a sensor module according to a third embodiment.

The sensor module 1 of the present embodiment is the same as that of the second embodiment described above except that the arrangement of the first and second fixing portions 21A and 21B is different. In the following description, the present embodiment will be described with a focus on the differences from the above-described first embodiment, and the description of the same matters will be omitted. In the drawings of the embodiment, the same configurations as those of the above-described embodiments have the same signs.

As illustrated in FIG. 12, in the sensor module 1 of the present embodiment, the first fixing portion 21A is disposed at the positive side in the X-axis direction with respect to the main body portion 20, and the second fixing portion 21B is disposed at the negative side in the X-axis direction with respect to the main body portion. That is, in the plan view from the Z-axis direction, a direction (X-axis direction) in which the first fixing portion 21A and the second fixing portion 21B are arranged and a direction (Y-axis direction) in which the flexible wiring portion 4 extends intersect each other. According to the configuration, the first and second fixing portions 21A and 21B do not overlap the flexible wiring portion 4 in the plan view from the Z-axis direction, and it is easy to fix the package 2 to the mounting board 91.

As described above, in the sensor module 1 of the present embodiment, in the plan view of the lower surface 2a, the direction in which the first fixing portion 21A and the second fixing portion 21B are arranged and the direction in which the flexible wiring portion 4 extends intersect each other. According to the configuration, the first and second fixing portions 21A and 21B do not overlap the flexible wiring portion 4 in the plan view from the Z-axis direction, and it is easy to fix the package 2 to the mounting board 91.

According to the third embodiment, the same effects as those of the above-described first embodiment can be exerted.

### Fourth Embodiment

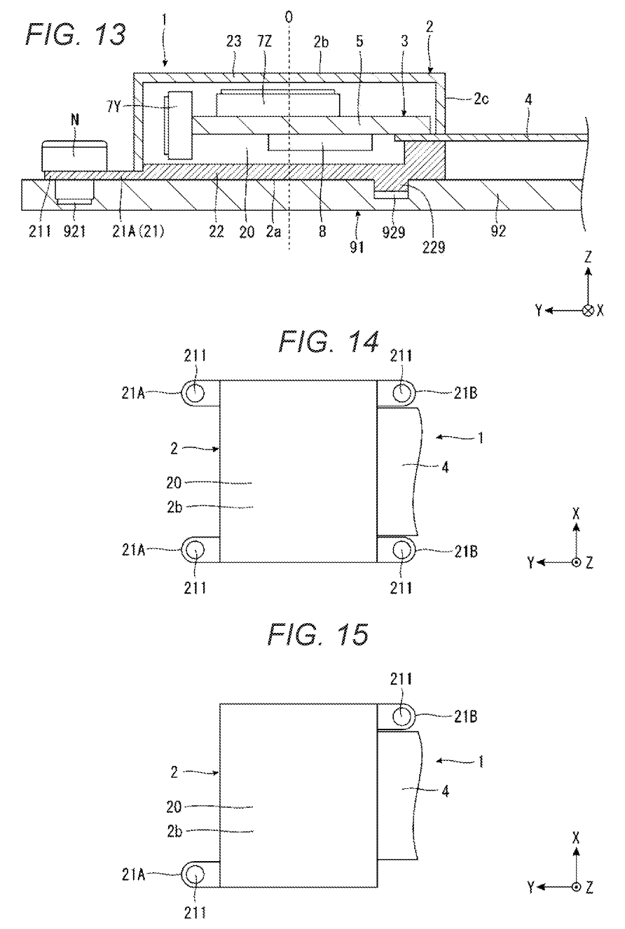

FIG. 13 is a cross-sectional view showing a sensor module according to a fourth embodiment.

The sensor module 1 of the present embodiment is the same as that of the first embodiment described above except that the configuration of the package 2 is different. In the following description, the present embodiment will be described with a focus on the differences from the above-described first embodiment, and the description of the same matters will be omitted. In the drawings of the embodiment, the same configurations as those of the above-described embodiments have the same signs.

As shown in FIG. 13, the inner case 22 has a columnar convex portion 229 protruding from the lower surface 2a. Further, the convex portion 229 is located at the negative side in the Y-axis direction with respect to a center O of the lower surface 2a, that is, at the flexible wiring portion 4 side. Further, the circuit substrate 92 of the mounting board 91 has a concave portion 929 with a bottom into which the convex portion 229 is fitted.

The sensor module 1 having the configuration is fixed to the circuit substrate 92 by engaging the convex portion 229 of the package 2 with the concave portion 929 and fastening the screw N inserted through the screw insertion hole 211 to the screw hole 921. As described above, by engaging the convex portion 229 with the concave portion 929, the attitude of the sensor module 1 becomes more stable. Further, since the number of screws N used for fixing can be suppressed to one as in the first embodiment described above, it is easy to mount the sensor module 1 on the mounting board 91. In particular, as in the present embodiment, by disposing the convex portion 229 at the negative side in the Y-axis direction with respect to the center O, the screw insertion hole 211 and the convex portion 229 can be separated as much as possible. Therefore, the attitude of the sensor module 1 becomes even more stable.

As described above, in the sensor module 1 of the present embodiment, the package 2 has the convex portion 229 protruding from the lower surface 2a, and the convex portion 229 engages with the concave portion 929 formed in the mounting board 91. According to the configuration, the attitude of the sensor module 1 becomes more stable. In addition, since the number of screws N used for fixing can be suppressed to be smaller, it is easy to mount the sensor module 1 on the mounting board 91.

As described above, in the plan view of the lower surface 2a, the fixing portion 21 is disposed at the side opposite to the flexible wiring portion 4, and the convex portion 229 is located at the flexible wiring portion 4 side with respect to the center O of the lower surface 2a. According to the configuration, the screw insertion hole 211 and the convex portion 229 can be separated as much as possible. Therefore, the attitude of the sensor module 1 becomes even more stable.

According to the fourth embodiment, the same effects as those of the above described first embodiment can be exerted.

As above, the sensor module of the present disclosure is described based on the illustrated embodiments, however, the present disclosure is not limited thereto. The configuration of each unit can be replaced with any configuration having the same function. Further, any other configuration may be added to the present disclosure. Furthermore, the respective embodiments may be appropriately combined.

For example, as modifications of the second embodiment described above, configurations shown in FIGS. 14 to 18 are exemplified. In the modifications shown in FIGS. 14 to 18, the screw insertion holes 211 are closed holes that are not open to the end surfaces of the first and second fixing portions 21A and 21B, however, the present disclosure is not limited thereto, and the screw insertion holes may be formed as cutouts that open to the end surfaces of the first and second fixing portions 21A and 21B.

In FIG. 14, the first fixing portion 21A is divided into two portions separated from each other in the X-axis direction, and the screw insertion hole 211 is formed in each of the two portions. The second fixing portion 21B is also divided into two portions separated from each other in the X-axis direction, and a screw insertion hole 211 is formed in each portion. The screw insertion hole 211 of the second fixing portion 21B does not overlap the flexible wiring portion 4 in the plan view from the Z-axis direction. According to the configuration, since the sensor module 1 is fixed to the mounting board 91 by the four screws N, the mounting stability of the sensor module 1 is increased.

In FIG. 15, the first fixing portion 21A is disposed at the negative side in the X-axis direction, and the second fixing portion 21B is disposed at the positive side in the X-axis direction. The screw insertion hole 211 of the second fixing portion 21B does not overlap the flexible wiring portion 4 in the plan view from the Z-axis direction. According to the configuration, the screw insertion holes 211 of the first and second fixing portions 21A and 21B can be separated from each other as much as possible. Therefore, the mounting stability of the sensor module 1 is increased.

In FIG. 16, the widths (lengths in the X-axis direction) of the first and second fixing portions 21A and 21B are smaller than the width (length in the X-axis direction) of the main body portion 20. According to the configuration, the footprint of the sensor module 1 can be reduced.

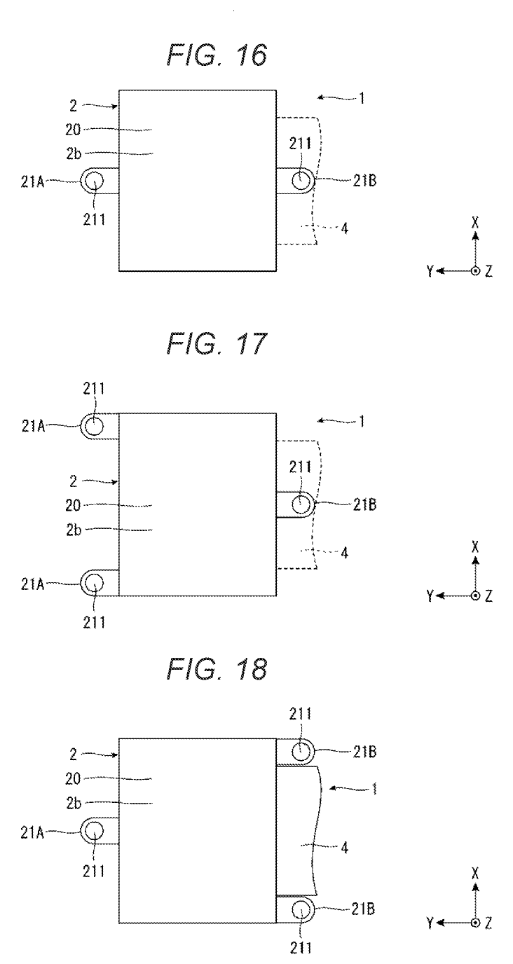

In FIG. 17, the first fixing portion 21A is divided into two portions separated from each other in the X-axis direction, and the screw insertion hole 211 is formed in each portion. The second fixing portion 21B is located at the center in the X-axis direction, and the width (length in the X-axis direction) thereof is smaller than the width (length in the X-axis direction) of the main body portion 20. According to the configuration, since the sensor module 1 is fixed to the mounting board 91 by the three screws N, the mounting stability of the sensor module 1 is increased.

In FIG. 18, the second fixing portion 21B is divided into two portions separated from each other in the X-axis direction, and the screw insertion hole 211 is formed in each portion. The first fixing portion 21A is located at the center in the X-axis direction, and the width (length in the X-axis direction) thereof is smaller than the width (length in the X-axis direction) of the main body portion 20. According to the configurations, since the sensor module 1 is fixed to the mounting board 91 by the three screws N, the mounting stability of the sensor module 1 is increased.

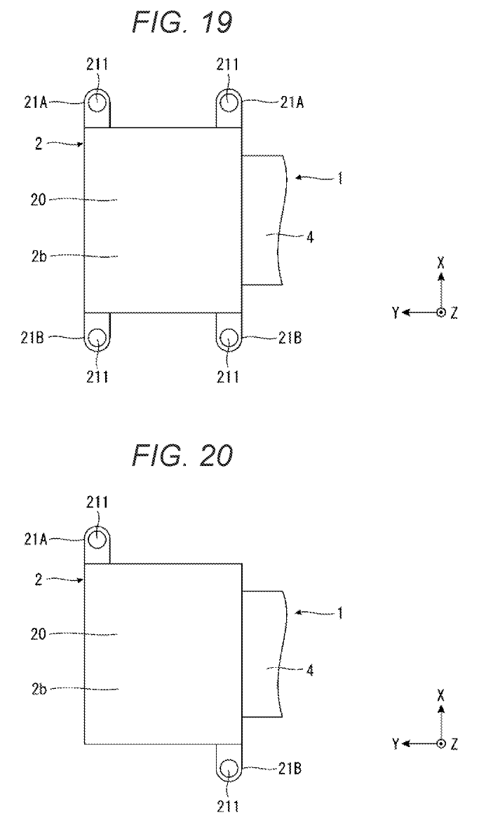

Further, for example, as modifications of the third embodiment described above, configurations illustrated in FIGS. 19 to 22 are exemplified. In the modifications shown in FIGS. 19 to 22, the screw insertion holes 211 are closed holes that are not open to the end surfaces of the first and second fixing portions 21A and 21B, however, the present disclosure is not limited thereto, and the screw insertion holes may be formed as cutouts that open to the end surfaces of the first and second fixing portions 21A and 21B.

In FIG. 19, the first fixing portion 21A is divided into two portions separated in the Y-axis direction, and the screw insertion hole 211 is formed in each portion. The second fixing portion 21B is also divided into two portions separated from each other in the Y-axis direction, and the screw insertion hole 211 is formed in each portion. According to the configuration, since the sensor module 1 is fixed to the mounting board 91 by the four screws N, the mounting stability of the sensor module 1 is increased.

In FIG. 20, the first fixing portion 21A is disposed at the positive side in the Y-axis direction, and the second fixing portion 21B is disposed at the negative side in the Y-axis direction. According to the configuration, the screw insertion holes 211 of the first and second fixing portions 21A and 21B can be separated from each other as much as possible. Therefore, the mounting stability of the sensor module 1 is increased.

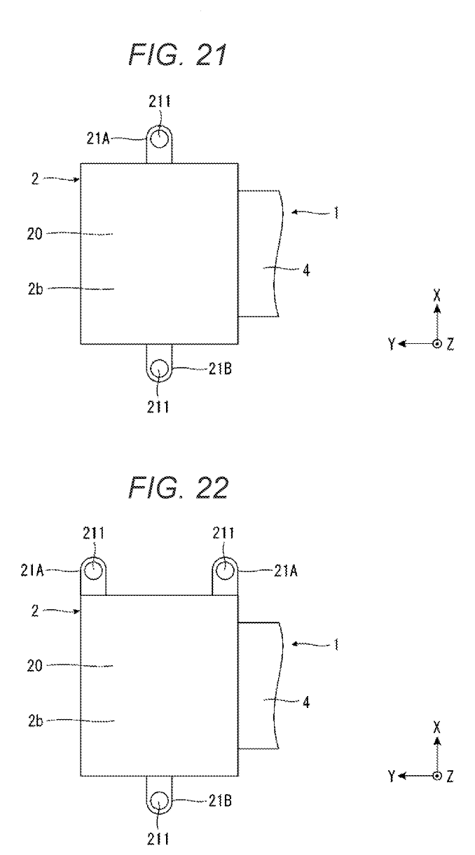

In FIG. 21, the first and second fixing portions 21A and 21B are located at the center in the Y-axis direction, and the widths (lengths in the Y-axis direction) of the first and second fixing portions 21A and 21B are smaller than the width (length in the Y-axis direction) of the main body portion 20. According to the configuration, the footprint of the sensor module 1 can be reduced.

In FIG. 22, the first fixing portion 21A is divided into two portions separated in the Y-axis direction, and the screw insertion hole 211 is formed in each portion. The second fixing portion 21B is located at the center in the Y-axis direction, and the width (length in the Y-axis direction) thereof is smaller than the width (length in the Y-axis direction) of the main body portion 20. According to the configuration, since the sensor module 1 is fixed to the mounting board 91 by the three screws N, the mounting stability of the sensor module 1 is increased.

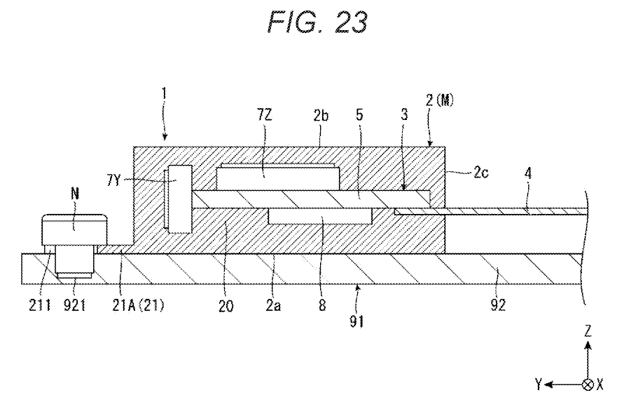

Further, for example, as shown in FIG. 23, the package 2 may be formed using a resin mold M.

What is claimed is:

1. A sensor module comprising:
a sensor substrate including a circuit substrate and an inertial sensor mounted on the circuit substrate;
a package including a main body portion having a first surface and a second surface in a front-back relationship and a side surface coupling the first surface and the second surface and housing the sensor substrate inside, and a fixing portion extending out from the main body portion along the first surface and fixed to an object; and
a flexible wiring portion electrically coupled to the sensor substrate and extending from the side surface to an outside of the package.

2. The sensor module according to claim 1, wherein
the circuit substrate and the flexible wiring portion are formed using a rigid flexible substrate including a rigid substrate as the circuit substrate and a flexible substrate as the flexible wiring portion.

3. The sensor module according to claim 1, wherein
a screw insertion hole through which a screw is inserted is formed in the fixing portion, and
the fixing portion is fixed to the object by the screw.

4. The sensor module according to claim 1, wherein
the fixing portion is disposed at a side opposite to the flexible wiring portion with respect to the main body portion in a plan view of the first surface.

5. The sensor module according to claim 1, wherein
the fixing portion includes a first fixing portion and a second fixing portion disposed at sides opposite to each other with respect to the main body portion in a plan view of the first surface.

6. The sensor module according to claim 5, wherein
in the plan view of the first surface,
the first fixing portion is disposed at a side opposite to the flexible wiring portion,
the second fixing portion is disposed at the flexible wiring portion side, and
the flexible wiring portion overlaps the second fixing portion and is fixed to the object together with the second fixing portion.

7. The sensor module according to claim 5, wherein
a direction in which the first fixing portion and the second fixing portion are arranged intersects a direction in which the flexible wiring portion extends out in the plan view of the first surface.

8. The sensor module according to claim 1, wherein
the package includes a convex portion protruding from the first surface, and
the convex portion engages with a concave portion formed in the object.

9. The sensor module according to claim 8, wherein
in a plan view of the first surface,
the fixing portion is disposed at a side opposite to the flexible wiring portion, and
the convex portion is located closer to the flexible wiring portion than a center of the first surface.
